(19) United States
(12) Patent Application Publication
(10) Pub. No.: US 2015/0256723 A1
(43) Pub. Date: Sep. 10, 2015

(54) SYSTEMS AND METHODS FOR OBTAINING ELECTRONIC IMAGES FROM WITHIN A STRONG MAGNETIC FIELD

(71) Applicant: OmniVision Technologies, Inc., Santa Clara, CA (US)

(72) Inventor: Junzhao Lei, San Jose, CA (US)

(73) Assignee: OmniVision Technologies, Inc., Santa Clara, CA (US)

(21) Appl. No.: 14/196,721

(22) Filed: Mar. 4, 2014

(51) Int. Cl. H04N 5/225

(52) U.S. Cl. CPC H04N 5/2252

(57) ABSTRACT

A system for obtaining an electronic image from within a strong magnetic field includes (a) a camera having an electronic image sensor for generating a first electrical image signal representative of the electronic image, and an electrical-to-optical converter for converting the first electrical image signal to an optical signal, (b) an optical-to-electrical converter for converting the optical signal to a second electrical image signal representative of the electronic image, and (c) an optical fiber for communicating the optical signal from the camera to the optical-to-electrical converter.

### BACKGROUND

Magnetic resonance imaging (MRI) is a common tool in medical diagnostics. MRI scanners use a combination of strong magnetic fields and radio waves to form images of a human body or body part. Typically, the primary magnetic field is generated by a super-conducting magnet and has a strength in the range from one Tesla to three Tesla. MRI scanners are capable of providing high-resolution three-dimensional images of a part of a human body, and therefore have utility for challenging radiology applications requiring spatially accurate imagery. The MRI images are generated by scanning a region of interest while probing hydrogen atoms in this region with radio-frequency pulses. Most procedures take between 20 and 90 minutes to complete.

Frequently, the quality of the MRI images is limited, or even compromised, by the patient moving during a scan. Even though fixtures are used to hold the patient as still as possible, it is virtually impossible to completely avoid movement. For example, breathing alone causes movement that is noticeable in images generated by high-resolution MRI scanners. This prevents the medical community from exploiting the full capability of the MRI system.

### SUMMARY

In an embodiment, a system for obtaining an electronic image from within a strong magnetic field includes (a) a camera having an electronic image sensor for generating a first electrical image signal representative of the electronic image, and an electrical-to-optical converter for converting the first electrical image signal to an optical signal, (b) an optical-to-electrical converter, for converting the optical signal to a second electrical image signal representative of the electronic image, and (c) an optical fiber for communicating the optical signal from the camera to the optical-to-electrical converter.

In an embodiment, a system for capturing an electronic image within a strong magnetic field includes an electronic image sensor for capturing the electronic image and generating an electrical image signal representative of the electronic image, an electrical-to-optical converter for converting the electrical image signal to an optical signal, and a fiber receptacle for coupling the optical signal to an optical fiber.

In an embodiment, a method for obtaining an electronic image from within a strong magnetic field includes capturing the electronic image using an electronic camera disposed within the strong magnetic field, converting the electronic image to an optical signal within the electronic camera, transmitting the optical signal through an optical fiber to a location external to the strong magnetic field, converting the optical signal to an electrical image signal representative of the electronic image at the external location.

### BRIEF DESCRIPTION OF THE DRAWINGS

FIG. 1 illustrates a system for obtaining electronic images from within a strong magnetic field using optical communication through an optical fiber, according to an embodiment.

FIG. 2 illustrates a method for obtaining an electronic image from within a strong magnetic field using optical communication through an optical fiber, according to an embodiment.

FIG. 3 illustrates an electronic camera for capture of electronic images within a strong magnetic field and conversion of the electronic images to an optical signal, according to an embodiment.

FIG. 4 illustrates an electromagnetically shielded electronic camera for capture of electronic images within a strong magnetic field and conversion of the electronic images to an optical signal, according to an embodiment.

FIG. 5 illustrates an electronic camera for capture of electronic images within a strong magnetic field and conversion of the electronic images to an optical signal, according to an embodiment.

FIG. 6 illustrates a method for converting an electrical image signal to an optical signal, according to an embodiment.

FIG. 7 illustrates a system for obtaining electronic images from within a strong magnetic field using optical communication through an optical fiber, according to an embodiment.

FIG. 8 illustrates a system for obtaining electronic images from within a strong magnetic field using optical communication through an optical fiber, wherein the system further includes an electrical communication path with the electronic camera capturing the electronic images, according to an embodiment.

FIG. 9 illustrates a method for obtaining electronic images from within a strong magnetic field using optical communication through an optical fiber, and further communicating electrical signals to the electronic camera capturing the electronic images, according to an embodiment.

FIG. 10 illustrates a system for obtaining electronic images from within a strong magnetic field using optical communication through two optical fibers, one optical fiber for transmitting signals out of the strong magnetic field and another optical fiber for transmitting optical signals into the strong magnetic field, according to an embodiment.

FIG. 11 illustrates a method for obtaining electronic images from within a strong magnetic field using optical communication through an optical fiber, and further optically communicating signals to the electronic camera capturing the electronic images through an additional optical fiber, according to an embodiment.

### DETAILED DESCRIPTION OF THE EMBODIMENTS

Disclosed herein are systems and methods for obtaining electronic images from inside a strong magnetic field. These systems and methods may be used to take optical images of a human body or body part while being subjected to an MRI scan. In this use scenario, an electronic camera is located inside the MRI scanner, in the tunnel occupied by the body part under examination. The electronic camera captures images of the body part. The images reveal movement of the body part. By capturing such images during an MRI scan, it is possible to correct for movement in the MRI images, by correlating the time sequence of MRI data with time sequence of images captured by the electronic camera. It is further possible to modify the MRI scan parameters to account for patient movement, as captured by the electronic camera, during the MRI scan. This reduces the impact of patient movement on the quality of MRI images.

In order for an electronic camera to function within a strong magnetic field, it must be at least partially shielded from the strong magnetic field. Without shielding, the electronic circuitry of the electronic camera would likely not function properly. In the case of an MRI scanner, electrical signals generated by the electronic camera may interfere with the radio-frequency pulses emitted and detected by the MRI scanner. Hence, high quality MRI images may require restricting the electrical signals of the electronic camera to a local region at the electronic camera. The same shield that protects the electronic camera from the strong magnetic field may provide such shielding and function as a general electromagnetic shield. However, retrieving the electronic images from within the MRI scanner requires communicating a signal from the electronic camera to a location external to the MRI scanner. The presently disclosed systems and methods utilize conversion of electronic images captured by the electronic camera to optical signals. The optical signals are communicated from the electronic camera to any desired location, without affecting the MRI scan and without being affected by the strong magnetic field. Likewise, signals may be communicated to the electronic camera as optical signals through an optical fiber.

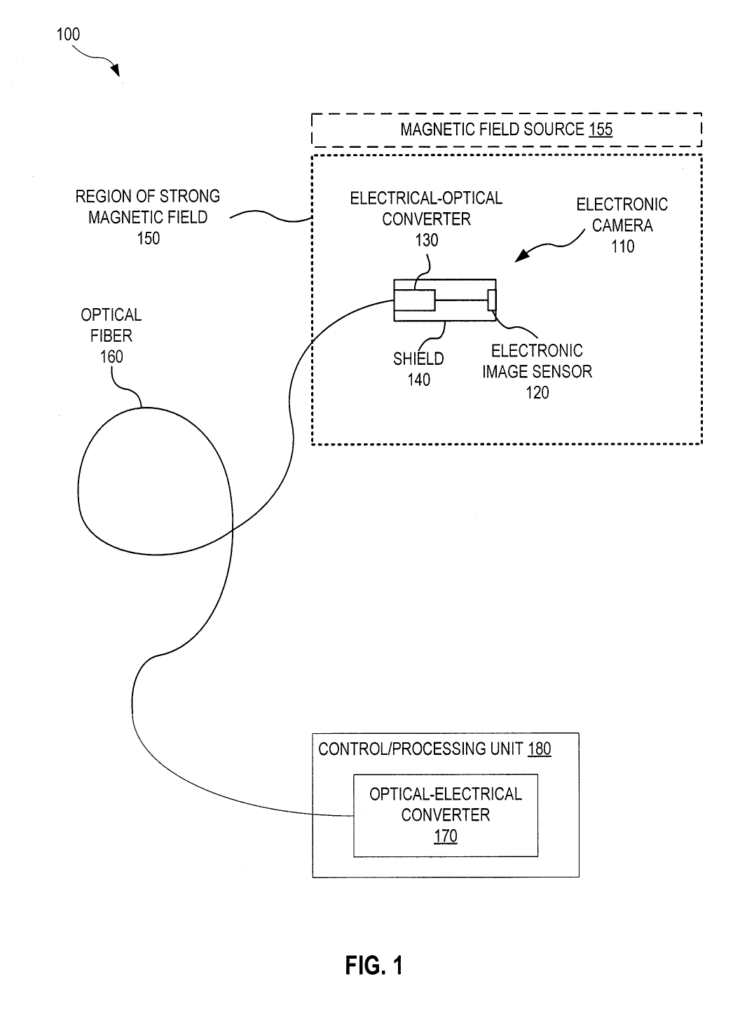

FIG. 1 illustrates one exemplary system 100 for obtaining electronic images from within a strong magnetic field. System 100 includes an electronic camera 110 located within a region of strong magnetic field 150. Electronic camera 110 includes an electronic image sensor 120 for capturing electronic images, an electrical-to-optical converter 130 for converting the electronic image to an optical signal, and a shield 140 for at least partially protecting the electronic components and electrical signals of electronic camera 110 from strong magnetic field 150. System 100 further includes an optical fiber 160 for communicating the optical signal to a control/processing unit 180 located externally to strong magnetic field 150. Control-processing unit 180 includes an optical-to-electrical converter 170 for converting the optical signal received from optical fiber 160 to an electrical signal representative of the electronic image captured by electronic image sensor 120. Control/processing unit 180 may further process the electrical signal generated by optical-to-electrical converter 170.

In certain embodiments, system 100 includes a magnetic field source 155 for generating strong magnetic field 150. In one embodiment, magnetic field source 155 includes one or more permanent magnets. In another embodiment, magnetic field source 155 includes one or more current-carrying wires, for example arranged in coils surrounding at least a portion of region of strong magnetic field 155. The current carrying wires may be superconducting wires. In yet another embodiment, magnetic field source 155 includes a combination of permanent magnets and current-carrying wires. Magnetic field source 155 may be incorporated in an MRI scanner.

In the present disclosure, strong magnetic field 150 is any magnetic field strong enough to perturb electrical signals and/or affect the function of electronic circuitry. Strong magnetic field 150 has a strength in the range of, for example, 0.1 Tesla to 20 Tesla. Strong magnetic field 150 may be a constant magnetic field, an alternating magnetic field, or a combination thereof. Shield 140 at least partially protects the electrical signals and electronic circuitry of electronic camera 110 from strong magnetic field 150. Without such protection, the electrical signals within electronic camera 110 potentially would be significantly distorted by strong magnetic field 150. Strong magnetic field 150 does not affect the optical signal generated by electrical-to-optical converter 130. This enables undistorted transmission of the electronic image, captured by electronic image sensor 120, to a location external to strong magnetic field 150 through transmission of the optical signal through optical fiber.

Shield 140 may be implemented as a part of electronic camera 110, as discussed above, or separate therefrom. For example, shield 140 may be a separate module configured such that an unshielded embodiment of electronic camera 110 may be installed therein. Alternatively, shield 140 may be implemented as part of the device that produces strong magnetic field 150, and configured for installation of an unshielded embodiment of electronic camera 110 therein.

Shield 140 at least partially shields the electronic components and electrical signals of electronic camera 110 from strong magnetic field 150 by reducing or eliminating strong magnetic field 150 in the local region of electronic camera 110. Shield 140 reduces the local magnetic field to a level that is acceptable for proper functioning of electronic camera 110. Shield 140 may further be configured to prevent electrical signals generated by the electronic camera 110 from leaving electronic camera 110, or at least attenuate electrical signals generated by electronic camera 110. In one embodiment, shield 140 is an enclosure that includes a material of high magnetic permeability. Examples include, but are not limited to, high magnetic permeability metal alloys, such as mu-metal and Permalloy In another embodiment, shield 140 is an enclosure that includes a nanocrystalline grain structure ferromagnetic metal coating or a superconducting material. Embodiments of shield 140 based on enclosing electronic camera 110 are configured as a partial enclosure, such that electronic camera is in optical communication with the scene imaged, and such that an optical signal may be transmitted from electronic camera 110. The enclosure may be further adapted to allow for other connections to electronic camera 110 through shield 140, for example a power connection or other connections required for the operation of electronic camera 110.

In an embodiment, control/processing unit 180 generates an electronic image from the electrical signal generated by optical-to-electrical converter 170, and displays this image on a display included in control/processing unit 180. In another embodiment, control/processing unit 180 processes the electrical signal to analyze aspects of the electrical signal. For example, control/processing unit 180 analyzes the electrical signal or the electronic image generated therefrom to generate data such as image contrast, brightness, object detection/recognition, or other desired data output associated with the electronic image.

Electronic image sensor 120 may be any type of image sensor capable of producing electronic images. In one embodiment, electronic image sensor 120 is a complementary metal-oxide semiconductor (CMOS) image sensor. In another embodiment, electronic image sensor 120 is a charge-coupled device (CCD) image sensor. Electronic image sensor 120 may capture isolated electronic images, a video stream, or a combination thereof. Electronic camera 110 may include a plurality of electronic image sensors 120, without departing from the scope hereof. Similarly, system 100 may include a plurality of electronic cameras 110 located within strong magnetic field 150 or a within a respective plurality strong magnetic fields 150, without departing from the scope hereof.

In one embodiment, optical fiber 160 is a single-mode optical fiber. In another embodiment, optical fiber 160 is a multi-mode optical fiber. Generally, a single-mode optical fiber outperforms multi-mode optical fibers in terms of retaining signal fidelity as the optical signal propagates through the fiber. Equivalently, for a given transmission distance and a given requirement to the fidelity of the transmitted optical signal transmitted, a single-mode optical fiber may transmit data at a higher bandwidth than multi-mode optical fibers. Accordingly, embodiments of system 100 with a large distance between electronic camera 110 and optical-to-electrical converter 170 may benefit from optical fiber 160 being a single-mode optical fiber. Likewise, in use scenarios with high bandwidth requirements, such as use scenarios that require transmission of a video stream captured by electronic image sensor 120, optical fiber 160 is advantageously implemented as a single-mode optical fiber. However, multi-mode optical fibers and the components associated with the use of multi-mode optical fibers are typically less expensive. Certain embodiments of system 100 or scenarios of its use may achieve the required performance using a multi-mode optical fiber. Optical fiber 160 may be of any length, for example in the range 0.5 meters to 100 meters. Optical fiber 160 may further include one or more units for amplification and/or reconditioning of the optical signal transmitted by optical fiber 160.

In an embodiment, electronic camera 110 is configured for installation in a spatially restricted area, such as that allowed in an MRI scan of a human body part. Electronic camera 110 is, for example, less than 5 millimeters in the dimension parallel with its imaging direction.

In another embodiment, the optical signal communicated through optical fiber 160 is an I²C signal, i.e., a signal according to the I²C protocol. In yet another embodiment, the signal communicated from electronic image sensor 120 to electrical-to-optical converter 130 is a D-phy signal, i.e., a signal according to the D-phy protocol.

In certain embodiments (not illustrated in FIG. 1), system 100 includes an additional optical fiber, an additional electrical-to-optical converter, and an additional optical-to-electrical converter for communicating signals to electronic camera 110 from control/processing unit 180. Examples of such signals include, but are not limited to, a reference clock signal and control signals for controlling image capture by electronic camera 110.

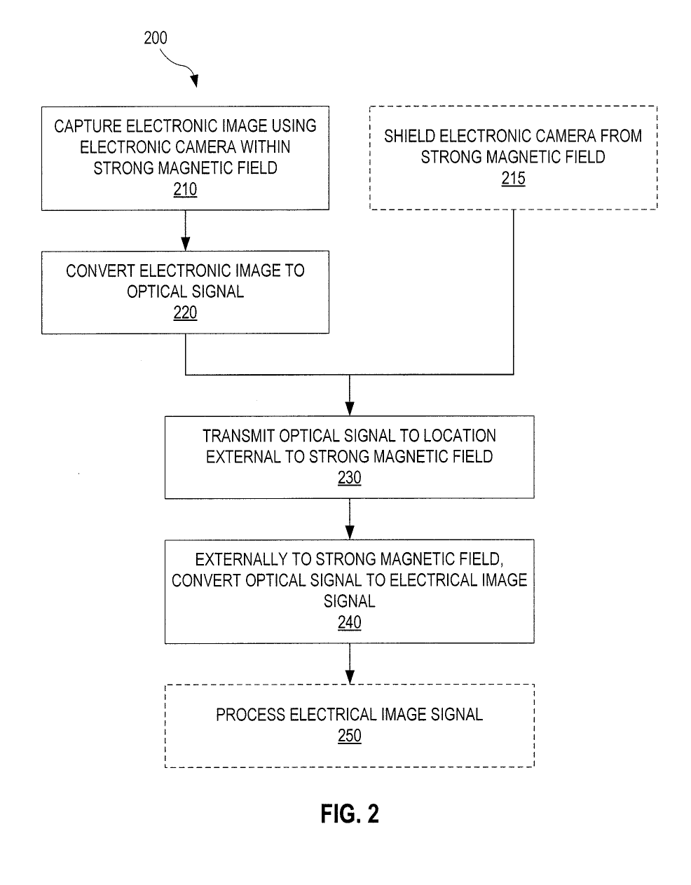

FIG. 2 illustrates one exemplary method 200 for obtaining an electronic image from within a strong magnetic field. Method 200 utilizes an electronic camera located in a region of strong magnetic field for capture of the electronic image. An optical fiber transmits the electronic image to a location external to the strong magnetic field. Method 200 is performed using, for example, system 100 of FIG. 1.

In a step 210, an electronic camera located within a strong magnetic field captures an electronic image. For example, electronic camera 110 (FIG. 1), located within strong magnetic field 150 (FIG. 1), uses electronic image sensor 120 to capture an electronic image. In a step 220, the electronic image captured in step 210 is converted to an optical signal. In an embodiment, the information of the electronic image is encoded in an optical signal as a sequence of light pulses, according to a defined encoding scheme. For example, electrical-to-optical converter 130 (FIG. 1) converts an electronic image captured by electronic image sensor 120 (FIG. 1) to an optical signal. In an optional step 215 the electronic components and electrical signals of the electronic camera are shielded from the strong magnetic field. Step 215 is executed in parallel with steps 210 and 220. Step 215 is performed, for example, by shield 140 (FIG. 1), which at least partially shields the electronic components and electrical signals from strong magnetic field 150 (FIG. 1). In certain embodiments, optional step 215 further includes attenuating or eliminating electrical signals emitted by the electronic camera away from the electronic camera.

In a step 230, the optical signal generated in step 220 is transmitted to a location external to the strong magnetic field. For example, optical fiber 160 (FIG. 1) transmits an optical signal generated by electrical-to-optical converter 130 (FIG. 1) to a location external to strong magnetic field 150 (FIG. 1). In a step 240, the optical signal transmitted in step 240 is converted to an electrical image signal that includes the information of the electronic image captured in step 210. Step 240 is performed in a location external to the strong magnetic field. For example, optical-to-electrical converter 170 (FIG. 1) converts the optical signal to an electrical image signal. In an optional step 250, the electrical image signal generated in step 240 is further processed. In an embodiment of step 250, the electrical image signal is processed to form an electronic image, which is displayed to a user. Step 250 may include further processing of the electrical image signal, or electronic image generated therefrom, to provide data as required in a given use scenario. For example, control/processing unit 180 (FIG. 1) processes an electrical image signal generated by optical-to-electrical converter 170 (FIG. 1) as appropriate for the use scenario.

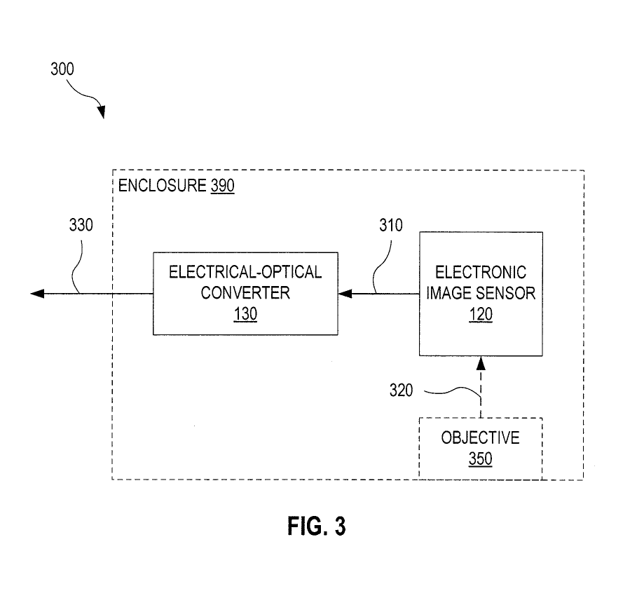

FIG. 3 illustrates one exemplary electronic camera 300 for capture of electronic images within a strong magnetic field and conversion of the electronic images to an optical signal. Electronic camera 300 is an embodiment of electronic camera 110 of FIG. 1. Electronic camera 300 includes electronic image sensor 120 (FIG. 1). Electronic image sensor 120 is communicatively coupled with electrical-to-optical converter 130 (FIG. 1) and an optional objective 350. In certain embodiments, electronic camera 300 further includes an enclosure 390 for holding and/or environmentally protecting the components of electronic camera 300. An image 320 is formed, optionally by objective 350, on electronic image sensor 120. Electronic image sensor 120 communicates an electrical image signal 310, representative of electronic image of image 320, to electrical-to-optical converter 130. Electrical-to-optical converter 130 generates and outputs an optical signal 330 that includes the information of electrical image signal 310.

In one exemplary use scenario, electronic camera 300 is installed in a local area that is at least partially protected from the strong magnetic field by a shield, such as shield 140 of FIG. 1. This shield may further prevent electrical signals generated by electronic camera 300 from leaving a local region around electronic camera 300, or at least attenuating such signals.

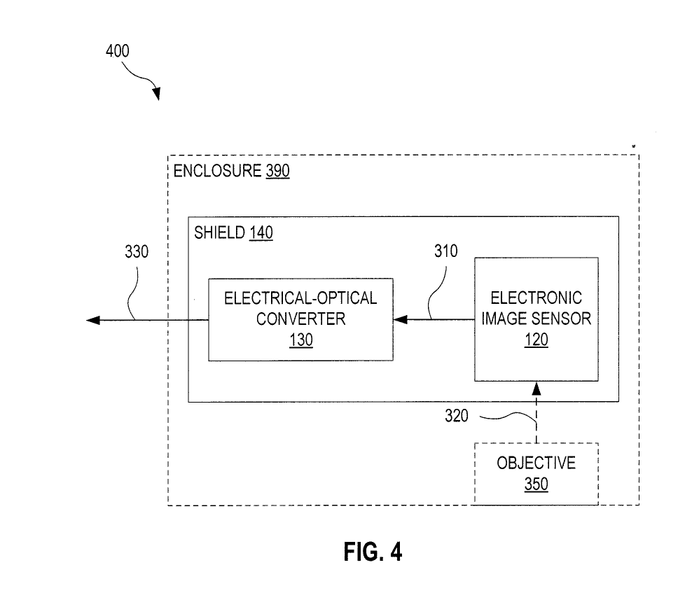

FIG. 4 illustrates one exemplary electronic camera 400 for capture of electronic images within a strong magnetic field and conversion of the electronic images to an optical signal. Electronic camera 400 is another embodiment of electronic camera 110 of FIG. 1. Electronic camera 400 is identical to electronic camera 300 (FIG. 3) except for further including shield 140 (FIG. 1), within optional enclosure 390. Shield 140 at least partially protects electronic image sensor 120, electrical-to-optical converter 130, and electrical image signal 310 from a strong magnetic field, as discussed in connection with FIG. 1. Shield 140 may further prevent or attenuate emission of electrical signals from electronic camera 400 away therefrom. In embodiments not illustrated in FIG. 4, shield 140 is located externally to optional enclosure 390 or is the same as optional enclosure 390.

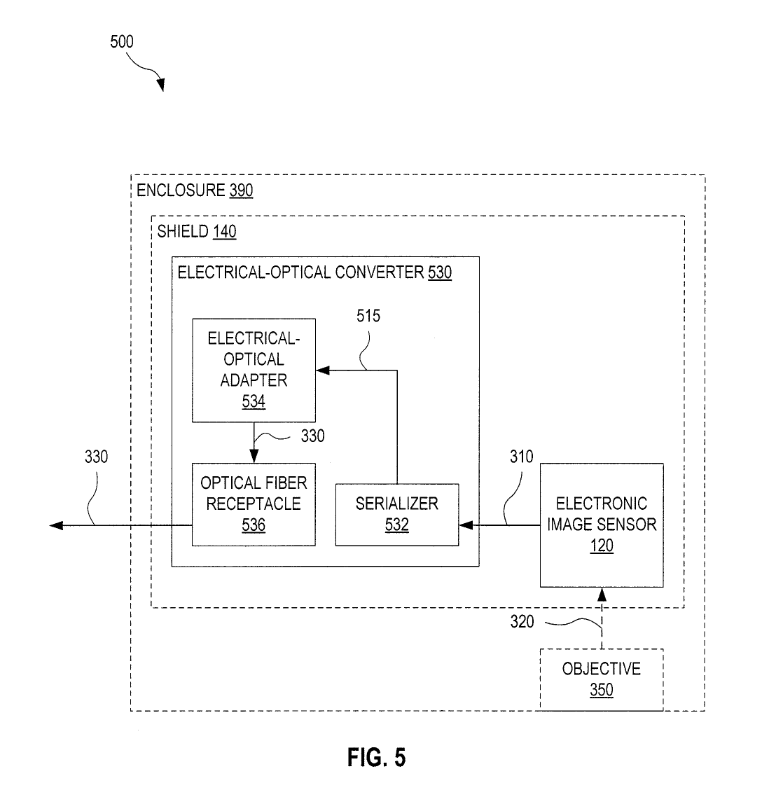

FIG. 5 illustrates one exemplary electronic camera 500 for capture of electronic images within a strong magnetic field and conversion of the electronic images to an optical signal. Electronic camera 500 is yet another possible embodiment of electronic camera 110 of FIG. 1. Electronic camera 500 is an extension of electronic camera 400 (FIG. 4). Electronic camera 500 includes electronic image sensor 120 (FIG. 1) for generating electrical image signal 310 (FIG. 3), which is representative of an electronic image of an image 320 (FIG. 3) formed on electronic image sensor 120, optionally by objective 350 (FIG. 3). Image sensor 120 communicates electronic image signal 310 to electrical-to-optical converter 530. Electrical-to-optical converter 530 is an embodiment of electrical-to-optical converter 130 (FIGS. 1, 3, and 4). Electrical-to-optical converter 530 includes a serializer 532, an electrical-to-optical adapter 534, and an optical fiber receptacle 536. Serializer 532 receives electrical image signal 310 from electronic image sensor 120. In this embodiment, electrical image signal 310 may be a parallel electrical signal. Serializer 532 processes electrical image signal 310 to form a serial electrical image signal 515, which is communicated to electrical-to-optical adapter 534. Serial electrical image signal 515 may be formatted according to the I²C protocol. Electrical-to-optical adapter 534 converts serial electrical image signal 515 to optical signal 330 (FIG. 3) and communicates optical signal 330 to optical fiber receptacle 536. Optical fiber receptacle 536 is configured for receiving an optical fiber, for example optical fiber 160 of FIG. 1, such that optical signal 330 may be coupled to the optical fiber for transmission through the optical fiber.

In certain embodiments, electronic camera 500 includes shield 140 for at least partial protection of electronic image sensor 120, serializer 532, electrical-to-optical adapter 534, electrical image signal 310, and serial electrical image signal 515. Optional shield 140 may further prevent or reduce emission of electrical signals from electronic camera 400. Optional shield 140 may be located within optional enclosure 390, as illustrated in FIG. 5, externally to optional enclosure 390, or be the same as optional enclosure 390. Optical fiber receptacle 536 may be located externally to optional shield 140, without departing from the scope hereof. In alternative embodiments, shielding functionality is provided separately from electronic camera 500, as discussed for electronic camera 110 in connection with FIG. 1. In an embodiment, electronic camera 500 further includes enclosure 390 (FIG. 3).

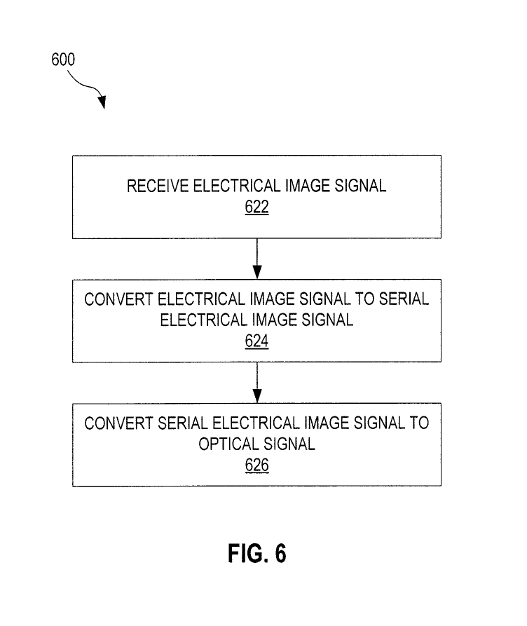

FIG. 6 illustrates one exemplary method 600 for converting an electrical image signal to an optical signal. Method 600 is an embodiment of step 220 of method 200 (FIG. 2), wherein the electronic image is expressed as an electrical image signal. Method 600 may be performed by electrical-to-optical converter 530 of system 500 (FIG. 5). In a step 622, an electrical image signal is received. For example, serializer 532 (FIG. 5) receives electrical image signal 310 (FIGS. 3 and 5) from electronic image sensor 120 (FIGS. 1 and 5). In a step 624, the electrical image signal received in step 622 is converted to a serial electrical image signal. The purpose of this step is to prepare an electrical image signal that is suitable for simple conversion to an optical signal. For example, serializer 532 (FIG. 5) converts electrical image signal 310 (FIGS. 3 and 5) to serial electrical image signal 515 (FIG. 5). In a step 626, the serial electrical image signal generated in step 624 is converted to an optical signal. For example, electrical-to-optical adapter 534 (FIG. 5) converts serial electrical image signal 515 (FIG. 5) to optical signal 330 (FIGS. 3 and 5).

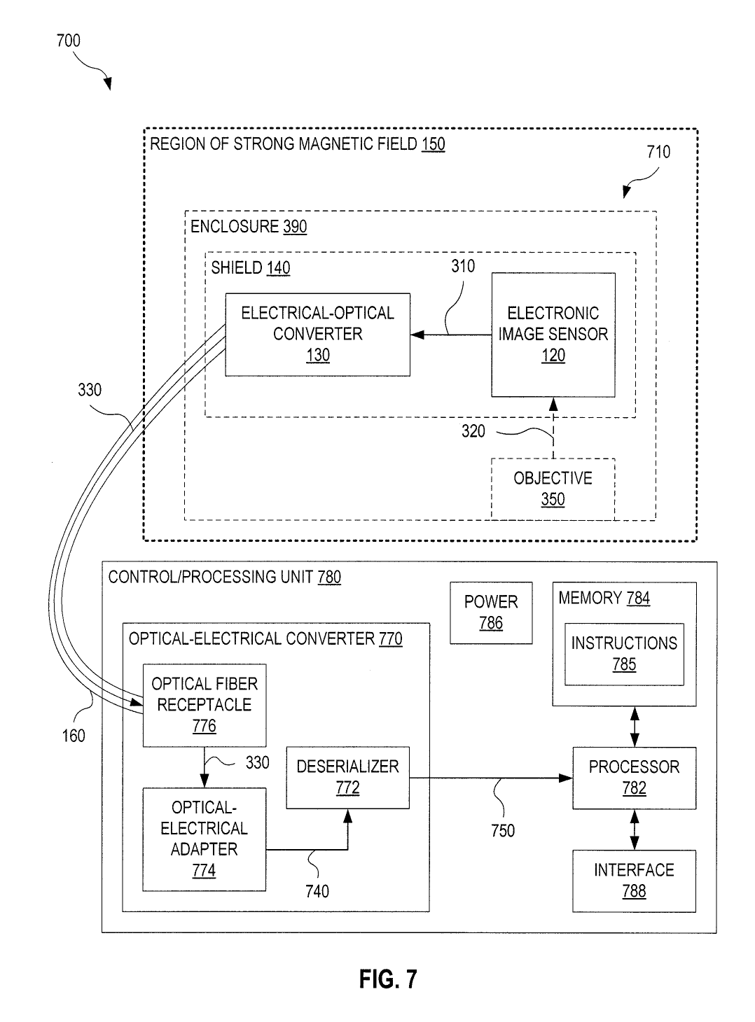

FIG. 7 illustrates one exemplary system 700 for obtaining electronic images from within a strong magnetic field. System 700 is an embodiment of system 100 (FIG. 1). System 700 includes an electronic camera 710 located within region of strong magnetic field 150, and a control/processing unit 780 located externally to strong magnetic field 150. Electronic camera 710 and control/processing unit 780 are communicatively coupled by optical fiber 160 (FIG. 1). Electronic camera 710 is identical to electronic camera 400 (FIG. 4), except that shield 140 is optional. In certain embodiments, electronic camera 710 includes shield 140, while in other embodiments, shielding functionality is provided separately from system 700, as discussed in connection with FIG. 1. Furthermore, optional shield 140 may be located within optional enclosure 390, as illustrated in FIG. 7, externally to optional enclosure 390, or be the same as optional enclosure 390.

Control/processing unit 780 is an embodiment of control/processing unit 180 of system 100 (FIG. 1). Control/processing unit 780 includes an optical-to-electrical converter 770, a processor 782, a memory 784, and an interface 788. Control/processing unit 780 further includes a power supply 786 for supplying power to the components of control/processing unit 780. Optical-to-electrical converter 770 includes an optical fiber receptacle 776, an optical-to-electrical adapter 774, and a deserializer 772. Optical-to-electrical converter 770 is an embodiment of optical-to-electrical converter 170 (FIG. 1).

Electronic camera 710 transmits optical signal 330 (FIG. 3) to control/processing unit 780 through optical fiber 160. Optical fiber receptacle 776 receives optical fiber 160 and communicates optical signal 330 to optical-to-electrical adapter 774. Optical-to-electrical adapter 774 converts optical signal 330 to a serial electrical image signal 740 and communicates serial electrical image signal 740 to deserializer 772. Deserializer 772 processes serial electrical image signal 740 to form an electrical image signal 750. In an embodiment, electrical image signal 750 is a parallel signal. In certain embodiments, electrical image signal 750 is substantially identical to electrical image signal 310. Deserializer 740 communicates electrical image signal 750 to processor 782. Processor 782 is communicatively coupled with memory 784, and processes electrical image signal 750 according to machine-readable instructions 785 located in a non-volatile portion of memory 784 and/or according to instructions received from interface 788. Processor 782 may store processed data, such as an electronic image generated from electrical image signal 750, to memory 784, and/or communicate processed data to an interface 788. In an embodiment, interface 788 includes a display. In another embodiment, interface 788 includes a keyboard, a touch screen, a pointing device, or other device for receiving instructions from a user. In yet another embodiment, interface 788 includes a wired or wireless interface, e.g., Ethernet, USB, Wi-Fi, or Bluetooth, for communicating processed data to a remote system and/or receiving instructions therefrom.

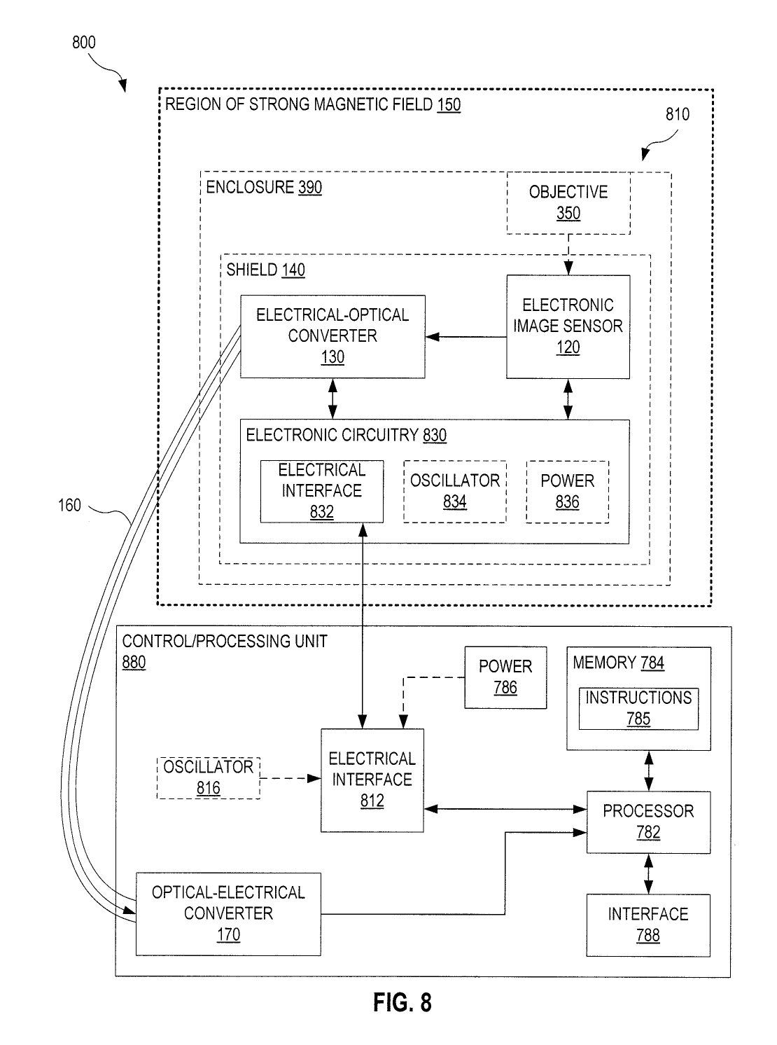

FIG. 8 illustrates one exemplary system 800 for obtaining electronic images from within a strong magnetic field. System 800 includes an electronic camera 810 located within region of strong magnetic field 150 and a control/processing unit 880 located externally to strong magnetic field 150. Electronic camera 810 and control/processing unit 880 are communicatively coupled both through optical fiber 160 (FIG. 1) and through an electrical connection, which will be discussed below. System 800 is another embodiment of system 100 (FIG. 1), which further includes functionality for controlling aspects of electronic camera 110 (FIG. 1), and supplying power thereto, from control/processing unit 180 (FIG. 1). Electronic camera 810 is an embodiment of electronic camera 110 (FIG. 1). Control/processing unit 880 is an embodiment of control/processing unit 180 (FIG. 1).

Electronic camera 810 includes electronic image sensor 120 (FIG. 1), electrical-to-optical converter 130 (FIG. 1), and, optionally, objective 350 (FIG. 3). Electronic image sensor 120, electrical-to-optical converter 130, and optional objective 350 are communicatively coupled and function as discussed in connection with FIG. 3. Electronic camera 810 further includes electronic circuitry 830 communicatively coupled with electrical-to-optical converter 130 and electronic image sensor 120. Electronic circuitry 830 includes an electrical interface 832 for receiving electrical signals from control/processing unit 880 and/or sending electrical signals to control/processing unit 880. In an embodiment, electronic circuitry 830 further includes a local oscillator 834 for supplying a clock signal to electrical-to-optical converter 130 and electronic image sensor 120. In another embodiment, electronic circuitry 830 further includes a power supply 836, such as a battery, for supplying power to the electronic components of electronic camera 810. In certain embodiments, electronic camera 810 includes shield 140 (FIG. 1) for at least partially protecting, from strong magnetic field 150, electronic image sensor 120, electrical-to-optical converter 130, electronic circuitry 830, and electrical signals associated these components. In alternative embodiments, shield 140 is provided separately from system 800, as discussed in connection with FIG. 1. Electronic camera 810 may further include enclosure 390 (FIG. 3). Optional shield 140 may be located within optional enclosure 390, as illustrated in FIG. 8, externally to optional enclosure 390, or be the same as optional enclosure 390.

Control/processing unit 880 includes power supply 786 (FIG. 7) and processor 782 (FIG. 7). Power supply 786 supplies power to the electronic components of control/processing unit 880. Processor 782 is communicatively coupled with interface 788 (FIG. 7) and memory 784 (FIG. 7) as discussed in connection with FIG. 7. Processor 782 is further communicatively coupled with optical-to-electrical converter 170 and electrical interface 812. Optionally, electrical interface 812 is configured to receive a power signal from power supply 786. In an embodiment, electrical interface 812 is communicatively coupled with a local oscillator 816, such that electrical interface 812 may receive a clock signal therefrom.

Processor 782 receives an electrical image signal from optical-to-electrical converter 170 in the same fashion as discussed in connection with FIG. 7, wherein processor 782 receives electrical image signal 750 from deserializer 772. As discussed in the case of system 700 (FIG. 7), processor 782 processes electrical image signals received from optical-to-electrical converter 170, according to instructions 785. Processor 782 further controls transmission of electrical signals to electrical interface 832 of electronic camera 810 through electrical interface 812 of control/processing unit 880, according to instructions 785 or according to input received through interface 788 (FIG. 7). Such electrical signals may include a power signal supplied by power supply 786, a clock signal generated by local oscillator 816, and control signals generated by processor 782 or electrical interface 812. The control signals are signals that control aspects of the functionality of electronic camera 810, for example, a trigger for triggering image capture by electronic image sensor 120, gain setting for electronic image sensor 120, exposure time setting for electronic image sensor 120, and settings for the operation of electrical-to-optical converter 130.

System 800 may further be configured for transmitting electrical signals from electrical interface 832 of electronic camera 810 to electrical interface 812 of control/processing unit 880. Examples of such signals include signals indicating the status of electronic camera 810, a signal indicating the occurrence of image capture by electronic image sensor 120, and a signal indicating the occurrence of optical signal transmission by electrical-to-optical converter 130.

In an embodiment, the electrical signals communicated between electrical interface 812 of control/processing unit 880 and electrical interface 832 of electronic camera 810 are configured for robust transmission through strong magnetic field 150. In another embodiment, not illustrated in FIG. 8, and optical fiber, for example optical fiber 160, is used to communicate signals from control/processing unit 880 to electronic camera 810.

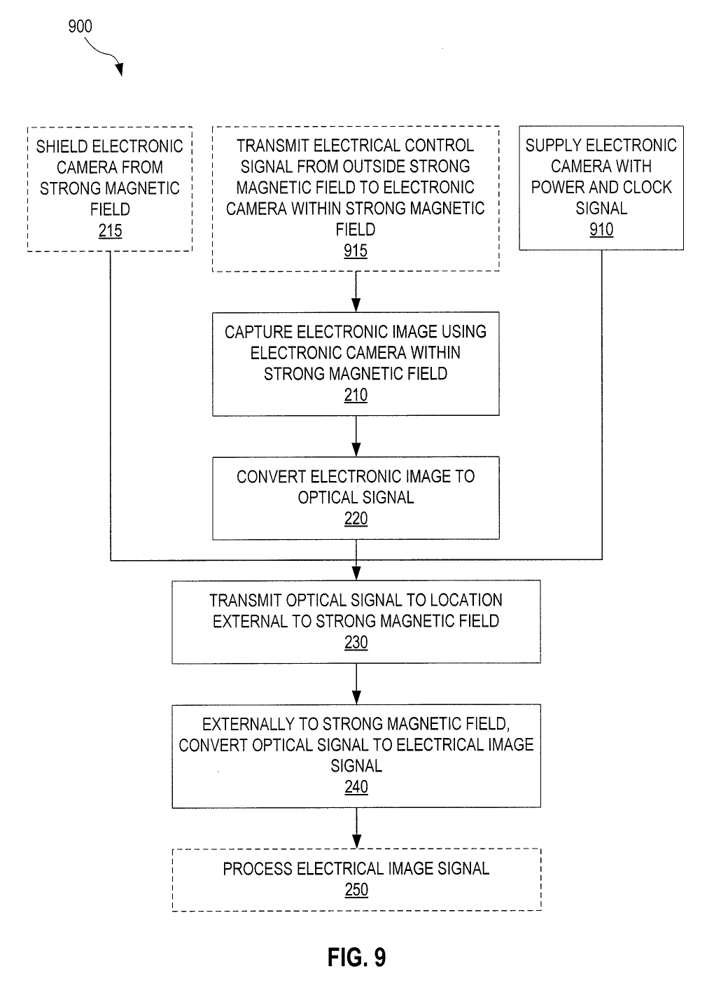

FIG. 9 illustrates one exemplary method 900 for obtaining an electronic image from an electronic camera located within a strong magnetic field, and controlling aspects of the functionality of the electronic camera using electrical signals. Method 900 is an embodiment of method 200 (FIG. 2) extended to include supplying the electronic camera with electrical signals. Method 900 may be performed, for example, by system 800 of FIG. 8.

In an optional step 915, an electrical signal is transmitted from outside the strong magnetic field to the electronic camera located within the strong magnetic field. The electrical control signal serves to control aspects of the functionality of the electronic camera as discussed in connection with system 800 of FIG. 8. For example, electrical interface 812 (FIGS. 7 and 8) of control/processing unit 880 (FIG. 8) transmits a control signal to electrical interface 832 (FIG. 8) of electronic camera 810 (FIG. 8). The transmission may be controlled by processor 782 (FIGS. 7 and 8) according to instructions 785 (FIGS. 7 and 8) or instructions received from interface 788 (FIGS. 7 and 8). From optional step 915, method 900 proceeds to perform steps 210 and 220 as discussed in connection with FIG. 2.

In a step 910, executed in parallel with steps 915, 210, and 220, power and a clock signal is supplied to an electronic camera located within a strong magnetic field. For example, electronic circuitry 830 (FIG. 8) supplies power and a clock signal to electronic image sensor 120 (FIGS. 1 and 8) and electrical-to-optical converter 130 (FIGS. 1 and 8). Electronic circuitry 830 (FIG. 8) may receive the power signal from optional power supply 836 (FIG. 8) or from power supply 786 (FIGS. 7 and 8) of control/processing unit 880 (FIG. 8) through electrical interface 812 (FIG. 8). Likewise, electronic circuitry 830 (FIG. 8) may receive the clock signal from optional local oscillator 834 (FIG. 8) or from optional local oscillator 816 (FIG. 8) of control/processing unit 880 (FIG. 8) through electrical interface 812 (FIG. 8).

Optionally, method 900 includes step 215 of method 200 (FIG. 2) executed in parallel with steps 915, 210, and 220, and in parallel with step 910. In an example, system 800 (FIG. 8) performs step 215 as discussed for system 100 (FIG. 1) in connection with FIG. 2.

After completion of step 220, method 900 proceeds to perform steps 230, 240, and 250 of method 200 (FIG. 2). For example, system 800 (FIG. 8) performs steps 230 and 240 as discussed for system 100 (FIG. 1) in connection with FIG. 2. Optional step 250 may be performed by processor 782 (FIGS. 7 and 8) of system 800 (FIG. 8) according to instructions 785 (FIGS. 7 and 8) or instructions received from interface 788 (FIGS. 7 and 8).

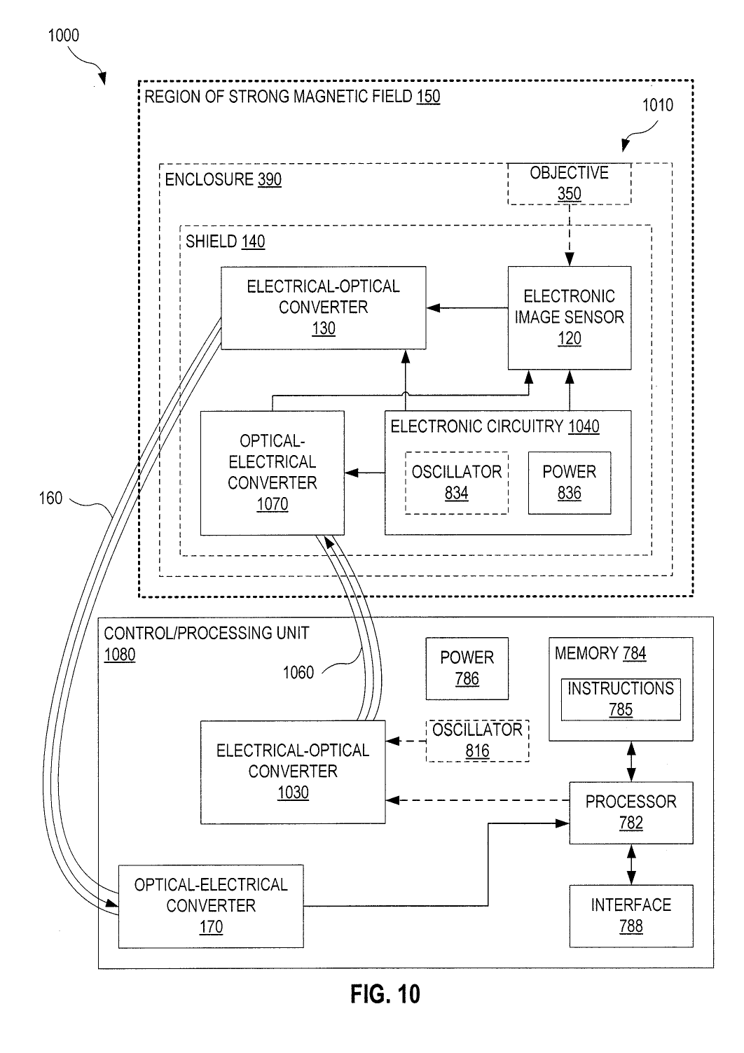

FIG. 10 illustrates one exemplary system 1000 for obtaining electronic images from within a strong magnetic field 150 (FIG. 1). System 1000 includes two-way optical communication between an electronic camera 1010 located within the strong magnetic field and a control/processing unit 1080 located externally thereto. System 1000 is configured to eliminate electrical communication from the control/processing unit 1080 to electronic camera 1010. Instead, signals may be optically communicated from control/processing unit 1080 to electronic camera 1010. This may be beneficial in settings with strict limitations on electrical signal interference. For example, electrical signals communicated to an electronic camera located within an MRI scanner may interfere with the electrical signals associated with operation of the MRI scanner.

Electronic camera 1010 communicates to control/processing unit 1080 through optical fiber 160 (FIG. 1), as discussed in connection with FIG. 8. Control/processing unit 1080 communicates to electronic camera 1010 through an optical fiber 1060. Optical fiber 1060 may be of the same type as optical fiber 160 or different therefrom.

Electronic camera 1010 includes electronic image sensor 120 (FIG. 1), electrical-to-optical converter 130 (FIG. 1), and, optionally, objective 350 (FIG. 3). Electronic image sensor 120, electrical-to-optical converter 130, and optional objective 350 are communicatively coupled and function as discussed in connection with FIG. 3. Electronic camera 1010 further includes electronic circuitry 1040 communicatively coupled with electrical-to-optical converter 130 and electronic image sensor 120. Electronic circuitry 1040 includes power unit 836 (FIG. 8). In an embodiment, electronic circuitry 1040 further includes local oscillator 834 (FIG. 8) for supplying a clock signal to electrical-to-optical converter 130 and electronic image sensor 120. Electronic camera 1010 further includes an optical-to-electrical converter 1070 for receiving optical signals from control/processing unit 1080, converting those optical signals to electrical signals, and communicating the electrical signals to electronic image sensor 120. Optical-to-electrical converter 1070 may be identical to optical-to-electrical converter 170 (FIG. 1).

In certain embodiments, electronic camera 1010 includes shield 140 (FIG. 1) for at least partially protecting, from strong magnetic field 150, electronic image sensor 120, electrical-to-optical converter 130, electronic circuitry 1040, and electrical signals associated these components. Furthermore, shield 140 may reduce or eliminate electrical signal leaving electronic camera 1010. In alternative embodiments, shield 140 is provided separately from system 1000, as discussed in connection with FIG. 1. Electronic camera 1010 may further include enclosure 390 (FIG. 3). Optional shield 140 may be located within optional enclosure 390, as illustrated in FIG. 10, externally to optional enclosure 390, or be the same as optional enclosure 390.

Control/processing unit 1080 includes power supply 786 (FIG. 7) and processor 782 (FIG. 7). Power supply 786 supplies power to the electronic components of control/processing unit 1080. Processor 782 is communicatively coupled with interface 788 (FIG. 7) and memory 784 (FIG. 7) as discussed in connection with FIG. 7. Processor 782 is further communicatively coupled with optical-to-electrical converter 170 and, optionally, an electrical-to-optical converter 1030. In one embodiment, electrical-to-optical converter 1030 is identical to electrical-to-optical converter 130. In another embodiment, electrical-to-optical converter 1030 does not include a serializer. For example, electrical signals received by electrical-to-optical converter 1030 from optional local oscillator 816 or processor 782 may be serial electrical signals. In an embodiment, control/processing unit 1080 further includes local oscillator 816 (FIG. 8) communicatively coupled with electrical-to-optical converter 1030.

Electrical-to-optical converter 1030 is communicatively coupled with optical-to-electrical converter 1070 of electronic camera 1010 through optical fiber 1060. Electrical signals communicated to electrical-to-optical converter 1030 from optional local oscillator 816 or processor 782 may be converted by electrical-to-optical converter 1030 to optical signals for communication to optical-electrical converter 1070 through fiber 1060. This facilitates the communication of a clock signal and/or control signals from control/processing unit 1080 to electronic camera 1010. Examples of control signals are discussed in connection with FIG. 8.

As discussed in connection with FIG. 8, processor 782 receives an electrical image signal from optical-to-electrical converter 170. Processor 782 processes electrical image signals received from optical-to-electrical converter 170, according to instructions 785.

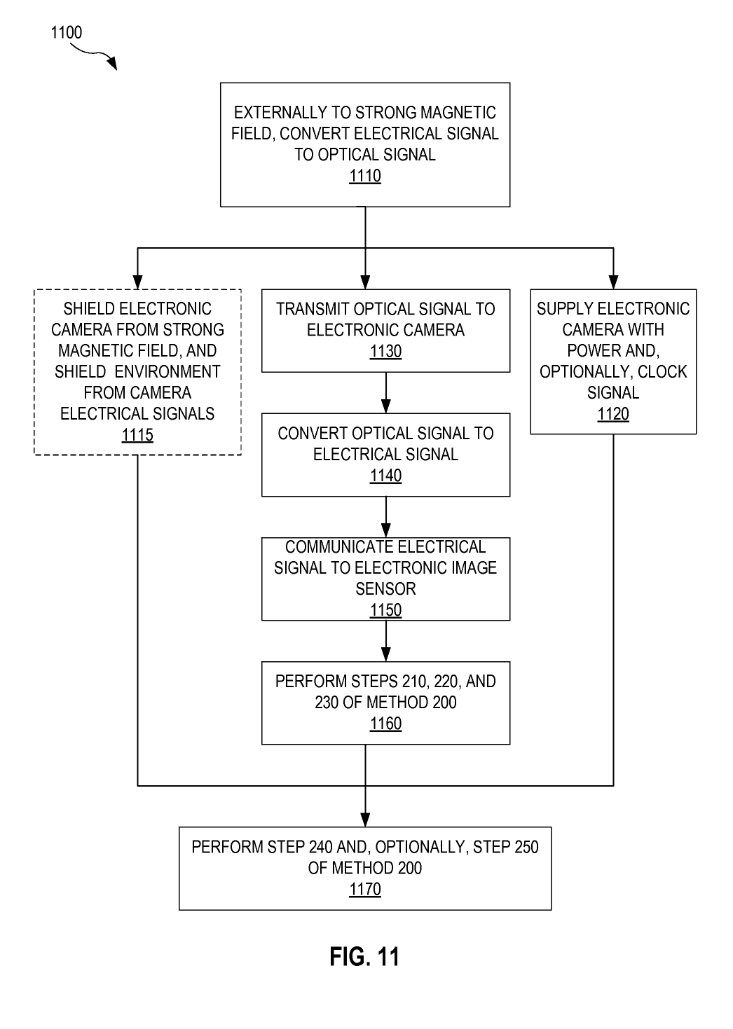

FIG. 11 illustrates one exemplary method 1100 for controlling aspects of the functionality of an electronic camera, located within a strong magnetic field, by using optical signals, as well as obtaining an electronic image from the electronic camera. Method 1100 is an extension of method 200 (FIG. 2) including supplying the electronic camera with signals, optically communicated thereto. Method 1100 may be performed, for example, by system 1000 of FIG. 10.

In a step 1110, performed externally to the strong magnetic field, an electrical signal, such as a clock signal or a control signal, is converted to an optical signal. For example, electrical-to-optical converter 1030 (FIG. 10) converts an electrical signal received from processor 782 (FIGS. 7 and 10) or optional local oscillator 816 (FIGS. 8 and 10) to an optical signal. From step 1010, method 1100 proceeds to steps 1120 and 1130, and, optionally, to step 1115.

In optional step 1115, the electronic camera is shielded from the strong magnetic field. The shield further attenuates or eliminates electrical signals emitted by and leaving the electronic camera. For example, shield 140 (FIGS. 1 and 10) protects the electronic components and electrical signals of electronic camera 1010 (FIG. 10) from strong magnetic field 150 (FIGS. 1 and 10), as well as protects the use environment from electrical signals generated by electronic components of electronic camera 1010 (FIG. 10). In a step 1120, the electronic camera is supplied with power and, optionally, a clock signal. For example, electronic camera 1010 (FIG. 10) receives power from integrated power supply 836 (FIGS. 8 and 10) and, optionally, a clock signal from local oscillator 834 (FIGS. 8 and 10).

In parallel with steps 1115 and 1120, method 1100 executes steps 1130, 1140, 1150, and 1160. In step 1130, the optical signal generated in step 1110 is communicated to the electronic camera. For example, electrical-to-optical converter 1030 (FIG. 10) communicates the optical signal through optical fiber 1060 (FIG. 10) to optical-to-electrical converter 1070 (FIG. 10). The generation and transmission of signals in steps 1110 and 1120 may be controlled by processor 782 (FIGS. 7 and 10) according to instructions 785 (FIGS. 7 and 10) or instructions received from interface 788 (FIGS. 7 and 10). This signal serves to control aspects of the functionality of the electronic camera as discussed in connection with system 800 of FIG. 8. In step 1140, the optical signal received by the electronic camera in step 1130 is converted to an electrical signal. For example, optical-to-electrical converter 170 (FIGS. 1 and 10) converts the optical signal to an electrical signal. In step 1150, the electrical signal generated in step 1140 is communicated to the electronic image sensor of the electronic camera. For example, optical-to-electrical converter 170 (FIGS. 1 and 10) communicates the electrical signal generated by optical-to-electrical converter 170 to electronic image sensor 120 (FIGS. 1 and 10). In step 1160, method 1100 executes steps 210, 220, and 230 of method 200 (FIG. 2). For example, electronic camera 1010 (FIG. 10) located within strong magnetic field 150 (FIGS. 1 and 10) captures an electronic image, converts the electronic image to an optical signal using electrical-to-optical converter 130 (FIGS. 1 and 10), and communicates the optical signal to optical-to-electrical converter 170 (FIGS. 1 and 10) through optical fiber 160 (FIGS. 1 and 10).

After completion of step 1160, method 1100 proceeds to a step 1170, wherein method 1100 executes step 240 and, optionally, step 250 of method 200 (FIG. 2). For example, system 1000 (FIG. 10) performs step 240 as discussed for system 100 (FIG. 1) in connection with FIG. 2. Optional step 250 may be performed by processor 782 (FIGS. 7 and 10) of system 1000 (FIG. 10) according to instructions 785 (FIGS. 7 and 10) or instructions received from interface 788 (FIGS. 7 and 10).

The presently disclosed systems and methods for obtaining an electronic image from within a strong magnetic field have utility also in scenarios that do not include a strong magnetic field. For example, the systems and methods for shielding the electrical signals generated by the electronic cameras of the present disclosure, as well as the optical communication with the electronic cameras allow for operation in settings that are sensitive to electrical signals and therefore have strict limitations thereon. Thus, the present systems and methods are directly applicable for use in electrically sensitive settings. Additionally, the optical communication of the present systems and method may offer benefits in situations where an image signal generated by an electronic camera must be communicated over a long distance.

Combinations of Features

Features described above as well as those claimed below may be combined in various ways without departing from the scope hereof. For example, it will be appreciated that aspects of one system or method for obtaining electronic images from within a strong magnetic field described herein may incorporate or swap features of another system or method for obtaining electronic images from within a strong magnetic field described herein. The following examples illustrate possible, non-limiting combinations of embodiments described above. It should be clear that many other changes and modifications may be made to the methods and device herein without departing from the spirit and scope of this invention:

(A) A system for obtaining an electronic image from within a strong magnetic field may include a camera, wherein the camera includes (i) an electronic image sensor for generating a first electrical image signal representative of the electronic image and (ii) an electrical-to-optical converter for converting the first electrical image signal to an optical signal.

(B) In the system denoted as (A), the camera may be located within the strong magnetic field.

(C) The system denoted as (B) may further include an optical-to-electrical converter for converting the optical signal to a second electrical image signal representative of the electronic image.

(D) The system denoted as (A) may further include an optical fiber for communicating the optical signal from the camera to a location external thereto.

(E) The system denoted as (A) may further include an optical-to-electrical converter for converting the optical signal to a second electrical image signal representative of the electronic image.

(F) In the system denoted as (E), the optical-to-electrical converter may be located externally to the strong magnetic field.

(G) Any of the systems denoted as (A) through (E) may further include a shield for at least partially protecting the camera from the strong magnetic field.

(H) In the system denoted as (G), the shield may be further configured to attenuate electrical signals emitted by the camera away therefrom.

(I) Any of the systems denoted as (A) through (H) may further include a control unit for controlling the camera.

(J) The system denoted as (I) may further include an electrical connection for transmitting electrical signals between the camera and the control unit.

(K) Either of the systems denoted as (I) and (J) may further include an additional optical fiber for transmitting optical signals from the control unit to the camera.

(L) Any of the systems denoted as (A) through (K) may further include a data processing system, located externally to the strong magnetic field, for processing the electronic image.

(M) In the system denoted as (L), the data processing system may include a display for displaying the electronic image.

(N) Any of the systems denoted as (A) through (M) may further include a magnetic field source for generating the strong magnetic field.

(O) In the system denoted as (N) the magnetic field source may be incorporated in a magneto resonance imaging scanner.

(P) In the systems denoted as (A) through (O), the electronic image sensor may be a CMOS image sensor.

(Q) In the systems denoted as (A) through (O), the electronic image sensor may be a CCD image sensor.

(R) A system for capturing an electronic image within a strong magnetic field may include (i) an electronic image sensor for capturing the electronic image and generating an electrical image signal representative of the electronic image and (ii) an electrical-to-optical converter for converting the electrical image signal to an optical signal.

(S) The system denoted as (R) may further include a fiber receptacle for coupling the optical signal to an optical fiber.

(T) Either of the systems denoted as (R) and (S) may further include a shield for at least partially protecting electronic components of the system from the strong magnetic field.

(U) In the system denoted as (T), the shield may be further configured to attenuate electrical signals emitted by the camera away therefrom.

(V) In any of the systems denoted as (R) through (U), the electrical-to-optical converter may include a serializer for converting the electrical image signal to a serial electrical signal, and an electrical-to-optical adapter for converting the serial electric signal to the optical signal.

(W) The system denoted as (V) may further include an oscillator for providing a clock signal to the serializer and the electronic image sensor.

(X) Any of the systems denoted as (R) through (V) may further include an oscillator for providing a clock signal to the electronic image sensor.

(Y) Any of the systems denoted as (R) through (X) may further include a port for receiving a clock signal from outside the strong magnetic field.

(Z) Any of the systems denoted as (R) through (Y) may further include a port for receiving control signals for controlling the camera.

(AA) In the system denoted as (Z), the port may be an optical port and the control signal may be an optical control signal.

(AB) In the system denoted as (Z), the port may be an optical port and the clock signal may be an optical clock signal.

(AC) In any of the systems denoted as (R) through (AB), the electronic image sensor may be a CMOS image sensor.

(AD) In any of the systems denoted as (R) through (AB), the electronic image sensor may be a CCD image sensor.

(AE) A method for obtaining an electronic image from within a strong magnetic field may include (i) capturing the electronic image using an electronic camera disposed within the strong magnetic field and (ii) within the electronic camera, converting the electronic image to an optical signal.

(AF) The method denoted as (AE) may further include transmitting the optical signal through an optical fiber to a location external to the strong magnetic field.

(AG) The method denoted as (AF) may further include, at the location external to the strong magnetic field, converting the optical signal to an electrical image signal representative of the electronic image.

(AH) Any of the methods denoted as (AE) through (AG) may further include at least partially shielding the electronic camera from the strong magnetic field.

(AI) Any of the methods denoted as (AE) through (AH) may further include attenuating electrical signals emitted from the camera away therefrom.

(AJ) Any of the methods denoted as (AE) through (AI) may further include transmitting an optical control signal to the electronic camera from a control unit located externally to the strong magnetic field.

(AK) In the method denoted as (AJ), the control signal may be a control signal for controlling at least a portion of the steps of capturing and converting the electronic image.

(AL) The method denoted as (AF) may further include transmitting an optical control signal to the electronic camera from a control unit located externally to the strong magnetic field.

(AM) In the method denoted as (AL), the control signal may be a control signal for controlling at least a portion of the steps of capturing, converting the electronic image, and transmitting the optical signal.

Changes may be made in the above systems and methods without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and device, which, as a matter of language, might be said to fall therebetween.

What is claimed is:

1. A system for obtaining an electronic image from within a strong magnetic field, comprising:
a camera comprising an electronic image sensor for generating a first electrical image signal representative of the electronic image, and an electrical-to-optical converter for converting the first electrical image signal to an optical signal;
an optical-to-electrical converter for converting the optical signal to a second electrical image signal representative of the electronic image; and
an optical fiber for communicating the optical signal from the camera to the optical-to-electrical converter.

2. The system of claim 1, further comprising a shield for at least partially protecting the camera from the strong magnetic field.

3. The system of claim 2, the shield further being configured to attenuate electrical signals emitted by the camera away therefrom.

4. The system of claim 1, further comprising a control unit for controlling the camera.

5. The system of claim 4, further comprising an electrical connection for transmitting electrical signals between the camera and the control unit.

6. The system of claim 4, further comprising an additional optical fiber for transmitting optical signals from the control unit to the camera.

7. The system of claim 1, further comprising a data processing system for processing the electronic image.

8. The system of claim 7, the data processing system comprising a display for displaying the electronic image.

9. The system of claim 1, further comprising a magnetic field source for generating the strong magnetic field, and wherein the camera is located within the strong magnetic field, and the optical-to-electrical converter is located externally to the strong magnetic field.

10. The system of claim 9, the magnetic field source being incorporated in a magneto resonance imaging scanner.

11. A system for capturing an electronic image within a strong magnetic field, comprising:
an electronic image sensor for capturing the electronic image and generating an electrical image signal representative of the electronic image;
an electrical-to-optical converter for converting the electrical image signal to an optical signal; and
a fiber receptacle for coupling the optical signal to an optical fiber.

12. The system of claim 11, further comprising a shield for at least partially protecting electronic components of the system from the strong magnetic field.

13. The system of claim 12, the shield further being configured to attenuate electrical signals emitted by the camera away therefrom.

14. The system of claim 11, the electrical-to-optical converter comprising a serializer for converting the electrical image signal to a serial electrical signal, and an electrical-to-optical adapter for converting the serial electric signal to the optical signal.

15. The system of claim 14, further comprising an oscillator for providing a clock signal to the serializer and the electronic image sensor.

16. The system of claim 11, further comprising a port for receiving a clock signal from outside the strong magnetic field.

17. The system of claim 11, further comprising a port for receiving control signals for controlling the camera.

18. The system of claim 17, the port being an optical port and the control signal being an optical control signal.

19. A method for obtaining an electronic image from within a strong magnetic field, comprising:
capturing the electronic image using an electronic camera disposed within the strong magnetic field;
within the electronic camera, converting the electronic image to an optical signal;
transmitting the optical signal through an optical fiber to a location external to the strong magnetic field; and
at the location external to the strong magnetic field, converting the optical signal to an electrical image signal representative of the electronic image.

20. The method of claim 19, further comprising at least partially shielding the electronic camera from the strong magnetic field.

21. The method of claim 20, further comprising attenuating electrical signals emitted from the camera away therefrom.

22. The method of claim 19, further comprising transmitting an optical control signal to the electronic camera from a control unit located externally to the strong magnetic field, the control signal controlling at least a portion of the steps of capturing, converting the electronic image, and transmitting the optical signal.
